(19) United States
(12) Patent Application Publication
(10) Pub. No.: US 2014/0067505 A1
(43) Pub. Date: Mar. 6, 2014

(54) METHOD AND SYSTEM FOR PERSONALIZATION OF VOUCHERS

(71) Applicants: Noam RON, Oranit (IL); Robert Cohen, Ra'anana (IL)

(72) Inventors: Noam RON, Oranit (IL); Robert Cohen, Ra'anana (IL)

(73) Assignee: SAGARMATHA LTD., Kfar Saba (IL)

(21) Appl. No.: 13/602,220

(22) Filed: Sep. 3, 2012

(51) Int. Cl. G06Q 30/02

(52) U.S. Cl. 705/14.25

(57) ABSTRACT

The subject matter discloses a method, comprising obtaining transaction history of a specific customer at a voucher related business, predicting future transactions of the specific customer at the voucher related business according to the transaction history of a specific customer, said future transactions are associated with a predefined time range; determining a personalized voucher to be issued to the specific customer for the predefined time range to be redeemed at the voucher related business according to the predicted future transactions, wherein at least one step of the method is performed by a processor.

### FIELD OF THE INVENTION

The subject matter relates generally to a method and system for personalization of vouchers or matching a voucher to a potential customer from a plurality of optional vouchers.

### BACKGROUND OF THE INVENTION

Customers are offered an opportunity to pre-purchase a voucher or a coupon that is valid for redemption during a pre-defined period in the future. Such offer may be presented in a web site, sent by an email, SMS message or by regular mail. The voucher or coupon may vary according to two parameters, the voucher's price and the voucher's full redemption value. For example, a voucher may state the following: “Purchase a voucher that can be redeemed for $100 worth of merchandise, but pay only $50”.

The voucher may be displayed on an internet web page and is accessible for everyone, or can be transmitted to a list of subscribers of a coupon service or a coupon website, such as Groupon.

In many cases, the voucher is valid during a pre-defined period of time, for example “The voucher must be redeemed between the dates of 1 Jan and 8 Jan. 2013”, or “The voucher must be redeemed between the hours 14-16 in August 2012”. The voucher may include conditions, for example, “The voucher can only be used when the customer's total purchase is greater than $200”, “The voucher is valid only on goods purchased from the fresh fruit and vegetables category” and the like. The conditions may represent restrictions such as “The voucher cannot be redeemed for cigarettes or alcohol”. The profit of such vouchers to the merchants is questionable and relies on the law of large numbers.

### SUMMARY

It is an object of the subject matter to disclose a method, comprising:

obtaining transaction history of a specific customer at a voucher related business;

predicting future transactions of the specific customer at the voucher related business according to the transaction history of a specific customer, said future transactions are associated with a predefined time range;

determining a personalized voucher to be issued to the specific customer for the predefined time range to be redeemed at the voucher related business according to the predicted future transactions, wherein at least one step of the method is performed by a processor.

In some cases, the personalized voucher is performed at a cash register of the voucher related business.

In some cases, the method comprises obtaining two or more possible vouchers, wherein the determined personalized voucher is selected from the two or more possible vouchers.

In some cases, the method comprises predicting an incremental profit for at least a portion of the two or mote possible vouchers and determining the personalized voucher according to the predicted incremental profit.

In some cases, the method comprises predicting a redemption probability of at least a portion of the two or more possible vouchers and determining the personalized voucher according to the predicted incremental profit multiplied by the redemption probability.

In some cases, the method comprises automatically generating a plurality of possible vouchers to be issued to the specific customer according to predefined values of predefined parameters. In some cases, the method comprises selecting one or more personalized vouchers to he issued to the specific customer from the automatically generated possible vouchers.

In some cases, the method comprises obtaining personal voucher related parameters, determining values for the personal voucher related parameters according to the transaction history of the specific customer and determining the personalized voucher according to the values determined for the personal voucher related parameters.

In some cases, the method comprises obtaining personal voucher related parameters, determining values for the personal voucher related parameters according to personal information of the specific customer and determining the personalized voucher according to the values determined for the personal voucher related parameters.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows an environment for determining a personalized voucher, according to exemplary embodiment of the subject matter;

FIG. 2 shows a computerized voucher personalization system for determining a personalized voucher, according to exemplary embodiment of the subject matter;

FIG. 3 shows a computerized method for determining a personalized voucher, according to exemplary embodiment of the subject matter.

### DETAILED DESCRIPTION

The subject matter discloses a method and system for determining a personalized voucher or coupon for a specific customer. The customer may be a person or an entity, such as an office purchasing from a business. The customer may receive a personalized coupon, in which the customer is required to pay only at the time of purchasing the item of the coupon. Alternatively, the may receive a personalized voucher, in which the customer is required to pay at the time of purchasing the voucher. The term voucher refers to both voucher and coupon or a combination of both, for simplicity. The method obtains transactional history information of the customer to which the voucher is to be issued. The method further obtains general business information from the voucher related business in which the customer is to redeem the voucher. The voucher may be determined by selecting the voucher from a pool of possible vouchers, for example a pool of 25 vouchers relevant to the voucher related business. Then, the method determines the voucher to he issued for the customer using the abovementioned information, in some exemplary cases, the method further comprises a step of predicting an incremental profit that each of the possible vouchers will yield if the customer will purchase and determining the voucher to he issued to the customer according, to the predicted incremental profit, for example determining the voucher with the highest predicted incremental profit.

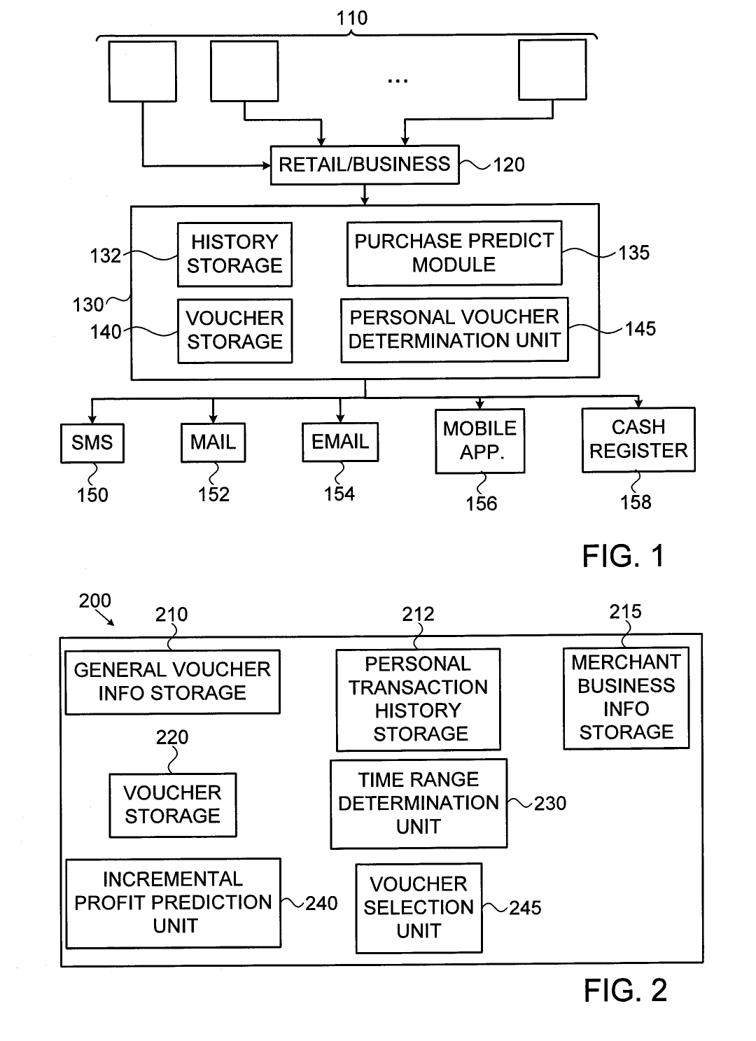

FIG. 1 shows an environment for determining a personalized voucher, according to exemplary embodiment of the subject matter. The environment comprises a plurality of customers 110 that purchase at a voucher related business 120 from time to time. The plurality of customers 110 have different purchase habits, for example different amounts spent per month, different amount of visits at the voucher related business 120 per year and the like. The voucher related business 120 or an entity authorized by the voucher related business 120 aggregates the different purchase habits of the plurality of customers 110 and transfers the different purchase habits to a voucher personalization system 130. The voucher personalization system 130 of the disclosed subject matter determines a personalized voucher to be issued to a specific customer of the plurality of customers 110.

The voucher personalization system 130 comprises a history storage 132 for storing a transaction history data of at least some of the plurality of customers 110 at the voucher related business 120. Such transaction history data includes, for example, the average number of products per purchase, averaged sum per purchase, previous use of vouchers and coupons, purchase distribution per departments at the voucher related business 120 and the like. The history storage 132 may be of flash memory, RAM, disc, magnetic memory or other computerized, magnetic or electronic memory.

The voucher personalization system 130 may also comprise a voucher storage 140. The voucher storage 140 comprises several vouchers associated with one or more voucher related businesses, such as the voucher related business 120. The vouchers at the voucher storage 140 may be of a simple structure, for example “pay $50 now, receive a voucher for $100” or of a complex structure, for example “pay $50 now, receive a voucher for $100 and the voucher can only be redeemed if the total purchase is above $200”. The vouchers stored at the voucher storage 140 may be limited to a time frame, for example “the voucher can be redeemed until Aug. 4, 2012”, “the voucher can be redeemed between August 10 and August 14” or “the voucher can be redeemed only on Saturdays and Sundays on September before noon”.

The voucher personalization system 130 further comprises a purchase prediction module 135. The purchase prediction module 135 receives the customer transaction history from the history storage 132 and predicts future transaction data of the customer. The future transaction data may include the data of the next purchase, total sum at the next purchase, total sum at the next two weeks and the like. The purchase prediction module 135 provides prediction of future purchases of a specific customer of the plurality of customers 110 at a specific business, such as the voucher related business 120. The purchase prediction module 135 provides prediction of future purchases of a specific product or a specific department at the voucher related business 120.

The voucher personalization system 130 further comprises a personal voucher determination unit 145. The personal voucher determination unit 145 obtains the customer transaction history from the history storage 132 and a prediction of future purchases from the purchase prediction module 135 and determines the personalized voucher to the specific customer accordingly. In some exemplary cases, the personal voucher determination unit 145 selects the personalized voucher from a plurality of optional vouchers stored at the voucher storage 140. In some exemplary cases, the personal voucher determination unit 145 performs mathematical or statistical computations in determining the personalized voucher to be issued to the specific customer of the plurality of customers 110.

After the personalized voucher is determined, the personalized voucher is issued to the specific customer. The personalized voucher may be transmitted to the specific customer via an SMS message 150, via an electronic message 154 or via regular mail 152, or via a mobile application 156. The personalized voucher may be offered to the specific customer at a cash register 158 of the voucher related business when purchasing goods or services at the voucher related business. For example, offer the specific customer “pay now %50 receive a voucher for $100”, as the voucher is limited for the next 7 days, and cannot be redeemed at the day of receipt of the personalized voucher. The personalized voucher may be transmitted in other means as desired by a person skilled in the art.

FIG. 2 shows a computerized voucher personalization system for determining a personalized voucher, according to exemplary embodiment of the subject matter. The voucher personalization system 200 comprises a personal transaction history storage 212, The personal transaction history storage 212 stores transaction history associated with a specific customer. The personal transaction history storage 212 may store transaction history of more than one customer, as long as the transaction history can be identified with a specific customer. The transaction history includes data related to products purchased, dates, prices, coupons and vouchers redemption, total sums and the like. This transaction history data can be obtained from the retailer's data or from credit/debit card data or from another source desired by the person skilled in the art.

The voucher personalization system 200 may also comprise a merchant business information storage 215. The merchant business information storage 215 stores data related, to the voucher related business. Such data may be an average gross margin of categories and/or products of the voucher related business. The average gross margin may be used in the calculation process in order to determine the best personalized voucher for a specific customer. Other data related to the voucher related business may be related to sales per product, per category and total sales in different periods of time, capacity of the business (how many customers could be served simultaneously), operating cost and the like.

The voucher personalization system 200 may also comprise a general voucher information storage 210. The general voucher information storage 210 stores information related to vouchers in general, such as the percentage of non-redeemed vouchers in different types of businesses (Restaurants, supermarkets, hotels etc), in different areas (southern California, Bay area LA, etc) and different periods of times and for a different types and values of vouchers, average of a sum spent above or below) the voucher value when voucher redeemed and the like.

The voucher personalization system 200 may also comprise a voucher storage 220. The voucher storage 220 comprises a plurality of possible vouchers that can be offered to a customer of the voucher related business. The voucher storage may store vouchers related to two or more voucher related businesses, such that when determining a personalized voucher for a customer of a specific voucher related business, only the relevant vouchers are offered for selection by a voucher selection unit 245. The voucher selection unit determines which of the several possible vouchers is determined to he issued for the specific customer. In some cases, the voucher selection unit 245 selects more than one voucher, for example in case two or more vouchers provide an expected profit higher than a predefined threshold, for example more than 12.5 US dollars.

The voucher personalization system 200 may also comprise a time range determination unit 230. The time range determination unit 230 determines the time range for redeeming the personalized voucher. The time range determined by the time range determination unit 230 may be determined according to data received from the purchase prediction module 135 of FIG. 1. The time range may be determined by data obtained from the personal transaction history storage 212. The time range may be “from now until May 7” or “from May 3 to May 23, after 18:00”. Differences in time ranges may be determined according to the voucher related business and per customer according to known transaction history of the specific customer.

The voucher personalization system 200 may also comprise an incremental profit prediction unit 240. The incremental profit prediction unit 240 predicts the incremental profit in case that a customer will purchase each one of a plurality of possible vouchers that potentially can be offered to him/her The incremental profit may he negative, positive or zero. The incremental profit prediction unit 240 obtains personalized information related to the specific customer, for example the customer's transaction history from the personal transaction history storage 212. The incremental profit prediction unit 240 may also obtain general voucher information from the general voucher information storage 210, such as percentage of unredeemed vouchers. The incremental profit prediction unit 240 may predict the incremental profit of two or more vouchers stored at the voucher storage 220. The incremental profit predicted by the incremental profit prediction unit 240 is transmitted to the voucher selection unit 245. The selection unit 245 selects one or more personalized vouchers to be issued to the specific customer. Determination of the incremental profit is detailed below.

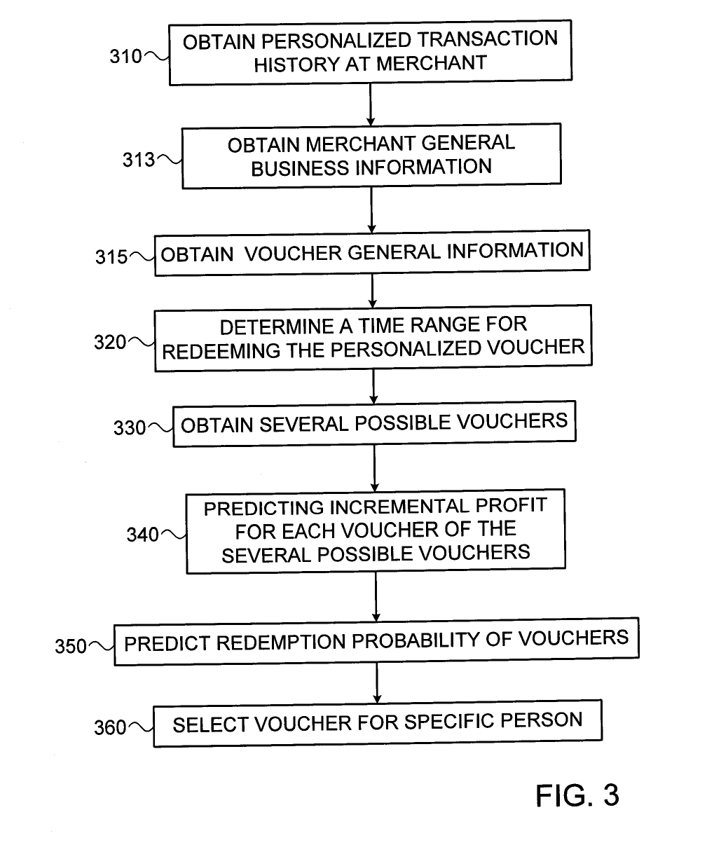

FIG. 3 shows a computerized method for determining a personalized voucher, according to exemplary embodiment of the subject matter. Step 310 discloses obtaining personalized transaction history at the voucher related business. The transactional history is aggregated by the voucher related business or by an adapted system installed at the voucher related business, for example at the cash register of the voucher related business. In some exemplary cases, the personalized transaction history may relate to two or more voucher related businesses cooperating with each other, so as to provide a personalized voucher while considering a greater amount personalized transaction history. The personalized transaction history is of the specific customer that later may receives the personalized voucher. The personalized transaction history may comprise dates of purchases, products purchased by the specific customer, amounts paid by the customer, credit history previous use of vouchers and coupons and the like.

Step 313 discloses obtaining merchant general business information. Such merchant general business information may include total sales of the voucher related business, products or departments that the voucher related business wishes to focus on, averaged purchase at the voucher related business during a predefined month, average gross margin and the like.

Step 315 discloses obtaining voucher general information The voucher general information may include the percentage of unredeemed vouchers and the like.

Step 320 discloses determining a time range for redeeming the personalized voucher. The time range may be determined, according to prediction of future transactions of the specific customer. Predictions of future transactions are determined according to transaction history of the specific customer. Predictions of future transactions may also be determined according to general business information of the voucher related business, for example rise of sales before a holiday and the like.

Step 330 discloses obtaining several possible vouchers from which the personalized voucher is selected by the voucher selection unit 245. The several possible vouchers may be stored at the voucher storage 220.

Step 340 discloses predicting incremental profit for possible personalized vouchers. The incremental profit is predicted for each possible voucher separately, and in relation to the specific customer. In some exemplary cases, the incremental profit is predicted according to the predicted sum spent by the customer in the business related voucher without the voucher during the voucher validation period, average gross margin of the voucher related business, the voucher's price and the voucher's full redemption value. The incremental profit may also take into consideration the percentage of non-redeemed vouchers and the average additional percentage that customers spend above the voucher's full redemption value or above the minimum spend required to redeem the voucher. For example, in case the voucher's full redemption value is $70 and customers that redeem this voucher spend $77 in average in the same business, the average additional percentage is 10%.

In some exemplary cases, the incremental profit of a possible voucher is determined as follows:

IP=NRP*VP+RP[(100+AAP)*MP*AGM−VD]−AGM*PPWV

Where IP refers to Incremental predicted Profit if the customer will redeem the voucher;

NRP refers to Non Redemption Probability, Which is the probability that the voucher is not redeemed;

VP refers to the Voucher's Price that customer have to pay in order to get the voucher. In the case of coupons where there is no upfront payment VP=0;

VD refers to the Voucher's Discount which is voucher value minus voucher price;

RP refers to Redeemed Probability which is 1−NRP;

MP refers to the maximum between Minimum Purchase to redeem the Voucher and the Full Redemption value;

AAP refers to the additional average percentage which is the percentage that customers predicted to spend over the Voucher's full redemption value;

AGM refers to Average Gross Margin of the voucher related business.

PPWV refers to the Purchase Prediction Without Voucher of the customer in the voucher related business.

As a numeric example, the average Gross Margin of the voucher related business is 60%, The Non Redemption Probability is 10% and the additional average percentage is %20. The voucher personalization system is instructed to require that only offers that produce positive Incremental Profit (IP) can he distributed. The purchase predictions without voucher (PPWV) of a specific customer according to the example is $70 at the time range of the voucher validity period. There are 4 possible vouchers:

Possible voucher 1—Pay $50 up front, receive a voucher for $100;

Possible voucher 2—Pay $90 up front, receive a voucher for $200;

Possible voucher 3—Pay $75 up front, receive a voucher for $150, can only be redeemed if total purchase is above $250;

Possible voucher 4—Pay $50 up front, and a further $100 on purchase, receive a voucher for $200.

The determination of the incremental profit is performed separately for each of the four possible vouchers, for the specific customer. Using the formula above, the incremental profit determined for each of the four possible vouchers as follows:

IP(Possible voucher 1)=10%*$50+90%(120%*$100*60%−$50)−60%*$70=−$17.2

IP(Possible voucher 2)=10%*$90+90%(120%*$200*60%−$110)−60%*$70=−$2.4

IP(Possible voucher 3)=10%*$75+90%(120%*$250*60%−$75)−60%*$70=−$60

IP(Possible voucher 4)=10%*$50+90%(120%*$200*60%−$50)−60%*$70=−$47.6

Step 350 discloses predicting a redemption probability for each possible voucher for each customer. The redemption probability may be predicted according to prediction of future transactions of the specific customer, known general and personal redemption statistics and the like.

Step 360 discloses selecting the personalized voucher for the specific customer. in some exemplary cases, each of the possible vouchers has a redemption probability that is determined by future prediction according to analysis of prior transactions or behavior of the specific customer. In the example disclosed above, the redemption probability of Possible voucher 1 is 70%, the redemption probability of Possible voucher 2 is 60%, the redemption probability of Possible voucher 3 is 20% and the redemption probability of Possible voucher 4 is 30%. As shown above, Possible voucher 1 and Possible voucher 2 yield negative incremental profits and assuming that the target function of the vouchers is increasing the profit, these vouchers are not eligible for distribution. When multiplying the incremental profit of Possible voucher 3 and Possible voucher 4 by the redemption probability, the result is as follows:

Possible voucher 3 Expected Profit=20%*$60=$12

Possible voucher 4 Expected Profit=30%*$47.6=$14.28

Then, the selection unit selects one or more personalized vouchers to be offered to the specific customer. In the example above, the selection unit selects Possible voucher 4. in some cases, more than one personalized voucher is offered to the same specific customer, for example in case the voucher personalization system determines to offers all personalized vouchers in which the incremental profit multiplied by the redemption probability is higher than $10.

The process of matching the best voucher for every customer may begin with a predefined set of potential vouchers as described above. In sonic other cases, the determining the most profitable voucher may be performed without predefined set of potential vouchers. In this case the voucher personalization system will determine the best parameters of the personalized voucher for every customer. Such parameters may include: voucher value, voucher price, voucher validity period, minimum required purchase required to redeem the voucher, and the list of products and/or services that can be porches with the voucher, Determining the most profitable voucher may include automatically generating a wide range of parameters to create a list of potential vouchers. For example, the voucher may have one or more values from the wide range of parameters disclosed above. Each value of the one or more values can have any value between the highest to the lowest transaction in the voucher related business during the last year the voucher price can be any percentage of the voucher value between 30% to 80%, etc.

The generation of the potential vouchers for the personalization process may be based on obtaining a plurality of voucher related parameters and a voucher generation formula. Upon obtaining the above, the method further comprises automatically generating a plurality of possible vouchers to be issued to the specific customer according to predefined values of voucher related parameters and using the voucher generation formula.

Following, this process of automatic creation of potential voucher list the voucher personalization system will perform the steps of selecting the personalized voucher or vouchers as described above, Another exemplary embodiment might be calculating all voucher personal parameters for a specific customer based on prediction of customer behavior and predefined principles. For example the voucher validity period can be the week with the lowest predicted sum spent by the customer in the voucher related business. The voucher value might be 3 times the predicted spend (without the voucher) during the validity period, the voucher value can be calculated to yield an incremental profit of $10.

The voucher personalization system can handle prepaid vouchers or coupons. The difference is that in the case of a voucher the business gets the voucher price in advance and in the case of a coupon the customer pays only when redeeming the coupon. As a result, the incremental profit calculation is different: there is no unredeemed voucher contribution in the case of coupons; and there might be a difference in the redemption probability, based on the individual behavior of each customer.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method, comprising:
obtaining transaction history of a specific customer at a voucher related business;
predicting future transactions of the specific customer at the voucher related business according to the transaction history of a specific customer, said future transactions are associated with a predefined time range;
determining a personalized voucher to be issued to the specific customer for the predefined time range to be redeemed at the voucher related business according to the predicted future transactions, wherein at least one step of the method is performed by a processor.

2. The method according to claim 1, wherein determining a personalized voucher is performed at a cash register of the voucher related business.

3. The method according to claim 1, further comprises obtaining two or more possible vouchers, wherein the determined personalized voucher is selected from the two or more possible vouchers.

4. The method according to claim 3, further comprises predicting an incremental profit for at least a portion of the two or more possible vouchers and determining the personalized voucher according to the predicted incremental profit.

5. The method according to claim 4, further comprises predicting a redemption probability of at least a portion of the two or more possible vouchers and determining the personalized voucher according to the determined incremental profit multiplied by the redemption probability.

6. The method according to claim 1, further comprises obtaining a plurality of voucher related parameters and a voucher generation formula.

7. The method according to claim 6, further comprises automatically generating a plurality of possible vouchers to be issued to the specific customer according to predefined values of voucher related parameters and using the voucher generation formula.

8. The method according to claim 7, further comprises selecting one or more personalized vouchers to be issued to the specific customer from the automatically generated possible vouchers.

9. The method according to claim 1, further comprises obtaining personal voucher related parameters, determining values for the personal voucher related parameters according to the transaction history of the specific customer and determining the personalized voucher according to the values determined for the personal voucher related parameters.

10. The method according to claim 1, further comprises obtaining personal voucher related parameters, determining values for the personal voucher related parameters according to personal information of the specific customer and determining the personalized voucher according to the values determined for the personal voucher related parameters.
